(19) United States
(12) Patent Application Publication
(10) Pub. No.: US 2011/0266773 A1
(43) Pub. Date: Nov. 3, 2011

(54) Multi-use transporter

(75) Inventor: Wayne Arthur Swanson, Gilford, NH (US)

(73) Assignee: Mr. Wayne Arthur Swanson, Gilford, NH (US)

(21) Appl. No.: 12/799,800

(22) Filed: May 3, 2010

(51) Int. Cl. B62D 63/06; B60P 3/00; B60D 1/52; B62D 63/08; B60D 1/00

(52) U.S. Cl. 280/415.1; 280/504

(57) ABSTRACT

A multi-use transporter towed behind a motor vehicle and by design of the load compensating movable platform, removable multi-use tow bar and various components thereon, it is capable of transporting one or more ladders, kayaks, canoes, bicycles, utility box etc. The transporter's base consists of one or more axles, high speed hubs and wheels, fenders and running lights. The transporter is also equipped with an approved hitch and safety chains or cables.

### FIELD OF THE INVENTION

This invention relates to a multi-use transporter. Through the use of various components thereon, it is capable of transporting ladders, kayaks, canoes, bicycles, camping equipment, household goods etc., when towed by a motor vehicle. The transporter is specifically designed for relatively effortless and secure mounting of the item(s) as well as facilitating stable travel and safe operation of the motor vehicle. The ability to store the transporter in a small area is a consideration as well.

### BACKGROUND

Four types of existing transporters in use today are: Utility, canoe, kayak and bicycle trailers. They all have a few things in common:

1) Use leaf spring trailer axles or torsion axles designed for specific weight limits.

2) Are generally long by design, therefore take up a lot of space when not in use.

3) Are equipped with required running lights, conventional tow hitch and safety chains or cables for safe operation, when towed by a motor vehicle.

Furthermore, known transporters mentioned are generally designed for one purpose.

### SUMMARY OF THE INVENTION

It is the object of the present invention to provide a multi-use transporter, towed by a motor vehicle, whereby an item(s) may be easily secured and removed. Said transporter having means to compensate for variable loads placed on the multi-use, movable platform.

It is also an object of the present invention to provide a means for the multi-use transporter whereby the transporter may be stored in its' normal operating position. And said transporter, requires a small area for storage.

It is another object of the present invention to provide a multi-use tow bar, which may be easily secured and removed from the transporter. Said tow bar having a conventional tow hitch, safety chains or cables and a folding, spring action platform support arm.

Another object of the present invention is to provide a multi-use tow bar, whereby said tow bar may be easily secured to one end of a ladder.

Another object of the present invention is to provide a multi-use tow bar, whereby said tow bar with specific components thereon, may be easily secured to one end of a kayak or canoe.

A further object of the invention is to provide the means for a bracket to be secured to the transporter's multi-use, movable platform. Whereby said bracket, with specific components thereon, may be easily secured to one end of a ladder, kayak or canoe.

A further object of the invention is to provide a means, so that a platform may be secured to the transporter's multi-use, movable platform and the multi-use tow bar. Said platform with specific components thereon, will support bicycles in their upright position and the bicycles may be easily secured and removed.

Another object of the invention is to provide a means, so that an open or enclosed utility box may be secured to the transporter's multi-use, movable platform and the multi-use tow bar.

Another object of the invention is to provide a means, so that the power cable leading from the transporter's running lights and forward to the motor vehicle will extend.

### BRIEF DESCRIPTION OF THE DRAWINGS

FIG. 1 is a front perspective view of the multi-use transporter, showing the multi-use tow bar and platform bracket attached.

FIG. 2 is a top perspective view of the multi-use tow bar.

FIG. 3 is a top side perspective view of the multi-use, movable platform showing holes for mounting bolts.

FIG. 4 is a bottom side perspective view of the multi-use, movable platform showing bladder retainers and threaded inserts for mounting bolts.

FIG. 5 is a top side perspective view of the transporter base showing the bladder retainers, extendible power cable storage compartment, wheels, fenders, lights, multi-use tow bar mounting plate and vertical/horizontal guide rails for the multi-use movable platform.

FIG. 6 is a top side perspective view of the transporter base as well, but in addition, shows the inflatable bladders in place.

FIG. 7 is a side perspective view of the transporter set up to tow an extension ladder.

FIG. 8 is a front perspective view of the multi-use tow bar secured to one end of an extension ladder. Also shown is the extendible power cable which is plugged into the tow vehicle to operate the transporter's running lights.

FIG. 9 is a rear perspective view of one end of an extension ladder secured to the bracket which is attached to the transporter's movable platform.

### DETAILED DESCRIPTION OF THE PREFERRED EMBODIMENTS

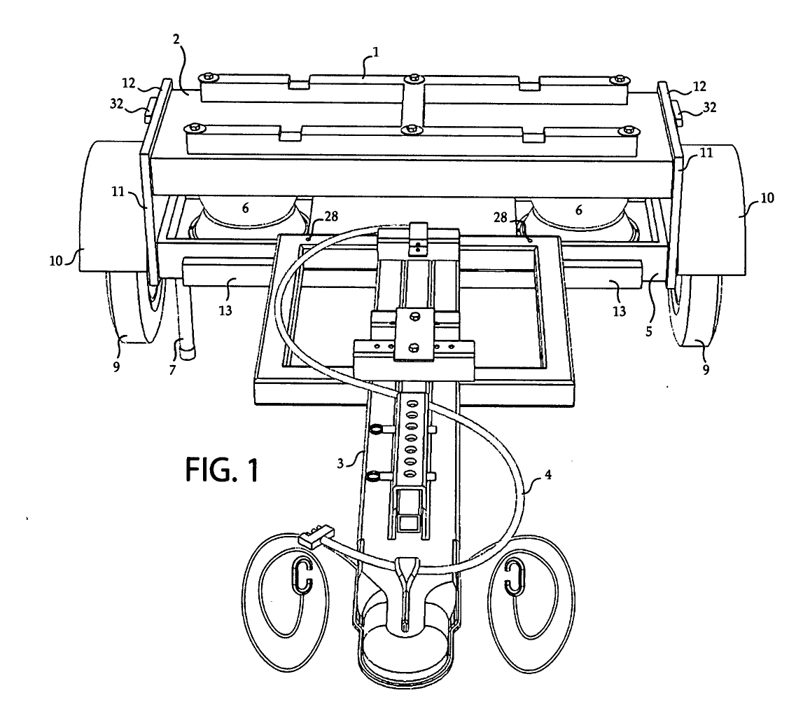

Turning now to FIG. 1, a detailed description of the multi-use transporter will be provided. A transporter for attachment to a motor vehicle is shown having a base 5 supported by wheels 9 on an axle (not shown) and said wheels having fenders 10. The movable platform 2 with bracket 1 thereon, is supported by inflatable bladders 6 and held in place by guide rails 11 and stop plates 12. Attached to each stop plate is a side marker light 32. Folding legs 7 (one shown) are use for balancing the transporter during set-up for a particular use and when stored without the multi-use tow bar 3 attached. The removable multi-use tow bar 3 is secured to the tow plate 13 with hardened machine bolts 28, washers and nuts (not shown). With the multi-use tow bar 3 secured to the tow plate 13, the extendible power cable 4 is easily tied to the tow bar.

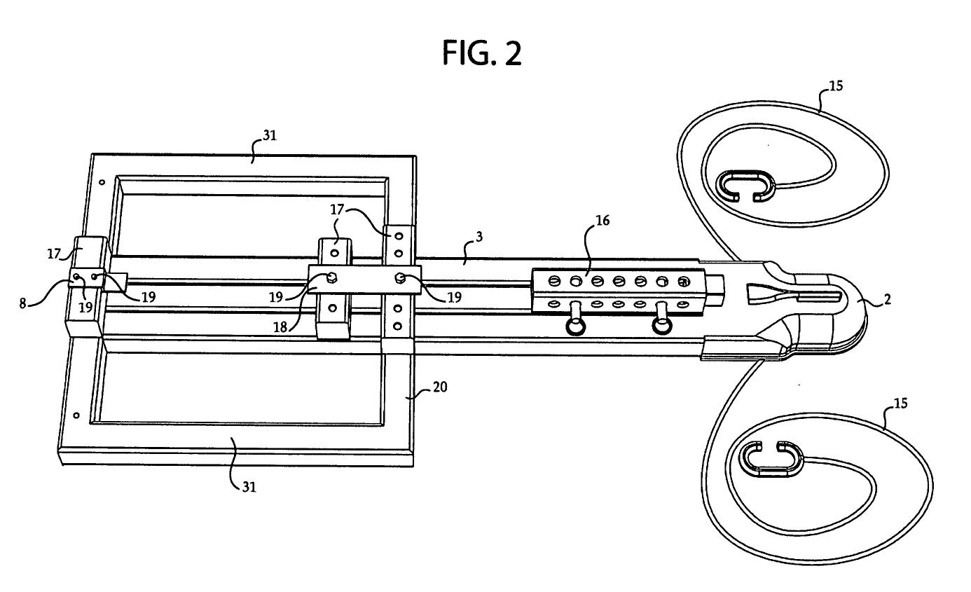

Turning now to FIG. 2, a detailed description of the multi-use tow bar will be provided. The multi-use tow bar 3 for securing to the transporter, one end of a ladder, kayak or canoe, is shown. The frame 20 serves two purposes. It is designed to fit inside the bottom side of the ladder 26 (not shown), where the rung keepers 17, hold-down plates 18 and bolts 19, securely hold the multi-use tow bar in place. Used separately, the frame rails 31 are designed to allow attachment thereon, kayak and canoe transporting saddles or pads (not shown). The folding, spring action support arm 16 is used when the multi-use tow bar is secured to the transporter and there is a special use platform (not shown) secured to the movable platform 2. A tow hitch 2 and safety chains or cables 15 are provided at the front end of the multi-use tow bar 3.

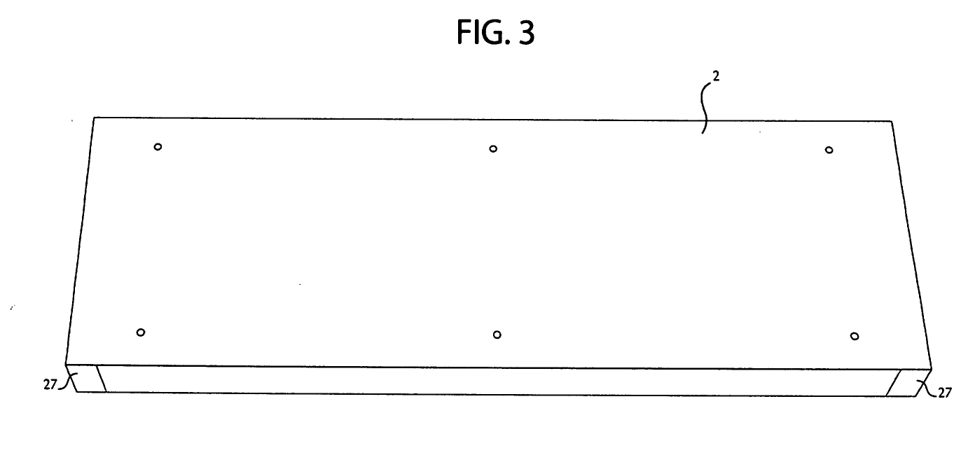

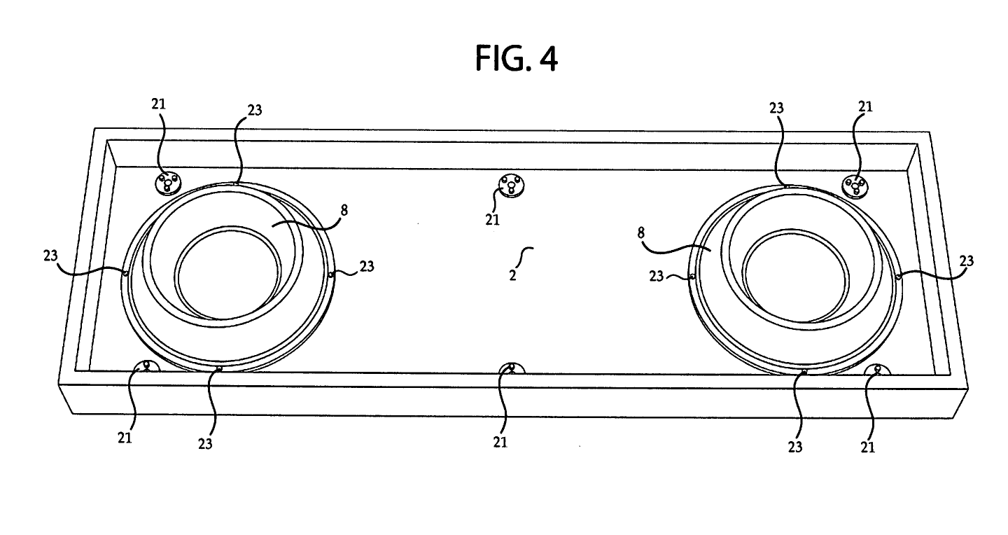

Turning now to FIGS. 3 and 4, a detailed description of the movable platform 2 will be provided. FIG. 3 shows one side and the top surface of the movable platform 2. Spaced apart on the top surface of the platform are mounting holes for bracket 1 (not shown) or a special use platform (not shown). In each corner are flat vertical/horizontal guides 27 (two shown). FIG. 4 shows the bottom side of the movable platform 2. Spaced apart on the bottom surface of the platform are retainers 8 for the inflatable bladders 6 (not shown). The retainers are held in place by, but not limited to screws 23. Also shown and spaced apart, are threaded inserts 21 for use with bolts 22 to secure bracket 1 (not shown) or a special use platform (not shown) to the movable platform 2.

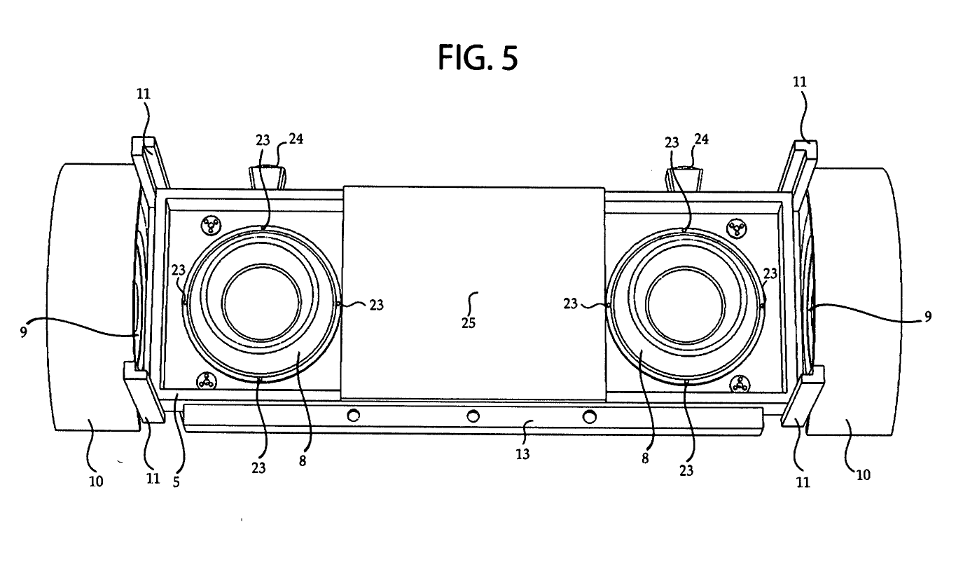

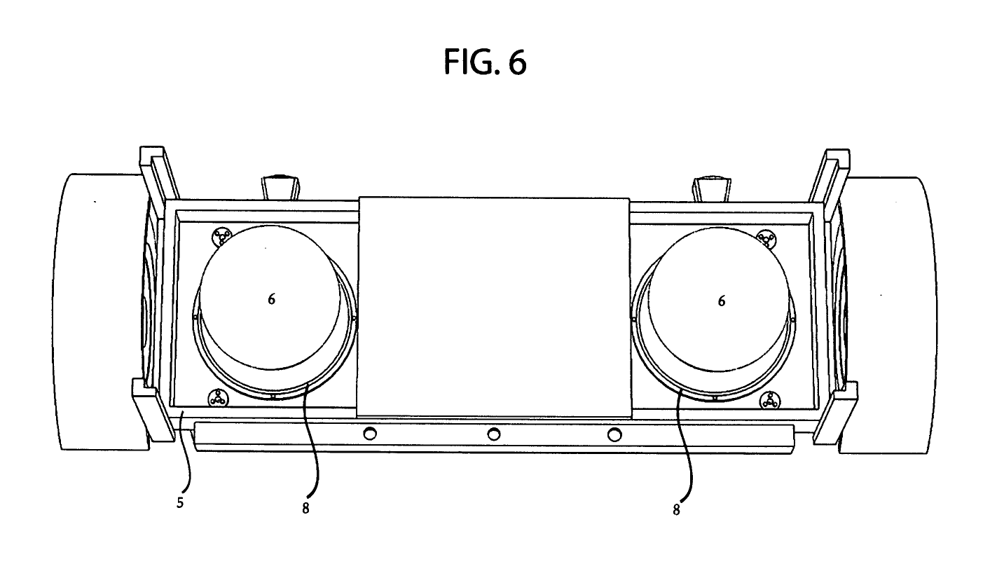

Turning now to FIGS. 5 and 6, a detailed description of the transporter base 5 as viewed from the top side will be provided. Shown and spaced apart, are retainers 8 for the inflatable bladders 6 (not shown). The retainers are held in place by, but not limited to screws 23. Shown between the retainers 8 is the hinged lid on the storage compartment 25 for the extendible power cable 4 (not shown). Running lights 24 are shown on the back side of base 5. On each corner of the base 5 and pointing upward, are the vertical/horizontal guide rails 11 for the movable platform 2 (not shown). Also shown is the multi-use tow bar mounting plate 13. In FIG. 6, the inflatable bladders 6 are shown being held in place by the transporter base retainers 8.

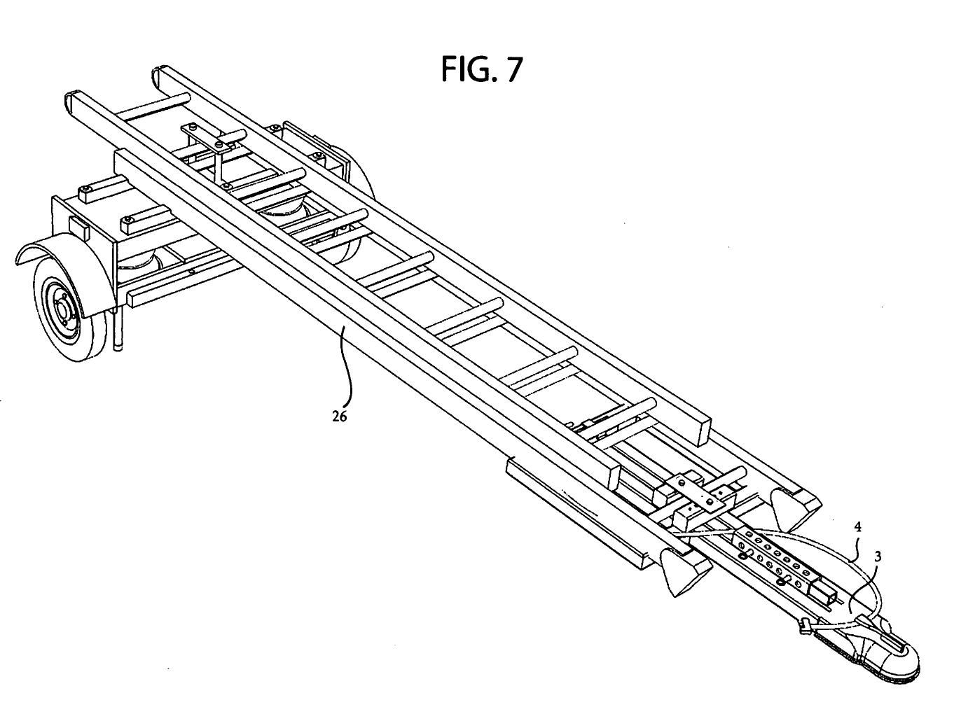

Turning now to FIG. 7, you will see a side view of the transporter with one end of an extension ladder 26 placed thereon. The multi-use tow bar 3 is shown attached to the opposite end of the extension ladder. Also shown is the extendible power cable 4.

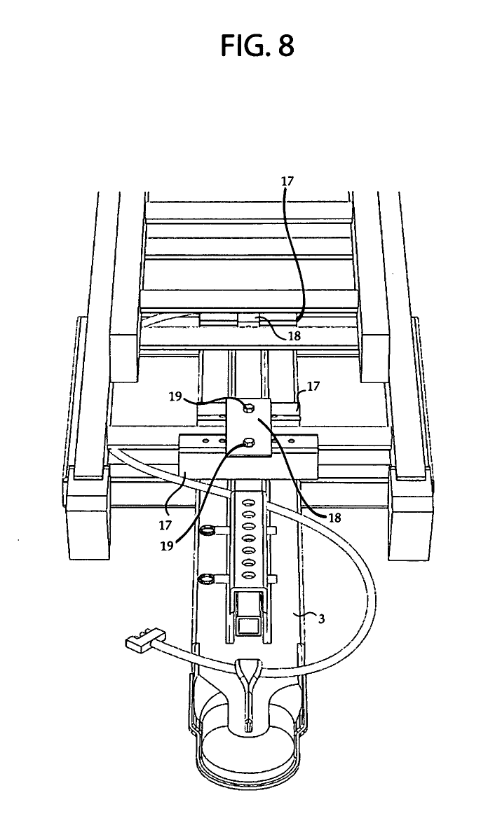

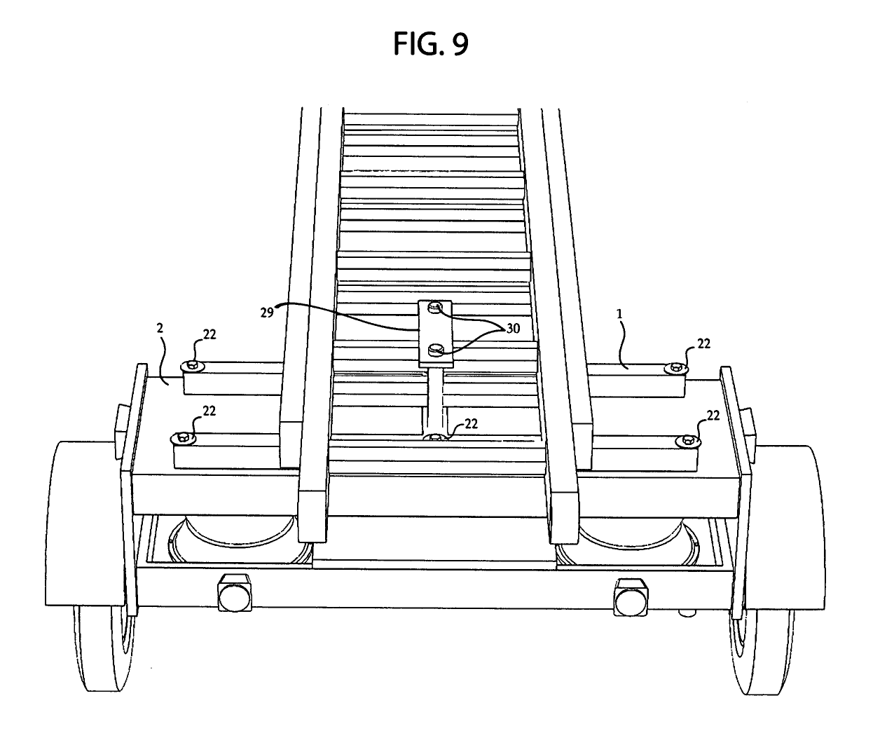

Turning now to FIGS. 8 and 9, a detailed description of the multi-use transporter as a ladder transporter will be provided. In FIG. 8, the multi-use tow bar 3 is secured to the last two ladder rungs by the tow bar frame fitting between the inside ladder rails and the up against the backside of the rungs. It is secured in place by rung keepers 17, hold-down plates 18 and bolts 19. In FIG. 9, bracket 1 is secured to the movable platform 2 with bolts 22. The opposite end of the ladder is fitted to bracket 1 and secured in place with hold-down plate 29 and hardened rung keeper bolts 30.

While the preferred embodiments of the present invention have been described, it should be recognized that various changes, adaptations, and modifications may be made therein without departing from the spirit of the invention and scope of the appended claims.

What is claimed is:

1) A multi-use transporter that is towed behind a motor vehicle by the use of a conventional axle(s), wheel(s) and a removable, multi-use tow bar.

2) A transporter base framework constructed of, but not limited to wood, composite material, metal, plastic or fiberglass. Said framework is held together by screws, bolts, welding etc. Said base comprising:
A preferred, but not limited to, steel mounting plate for the multi-use tow bar. Said plate being bolted or welded to the transporter's base.
Single, multiple, inflatable bladder(s), compression spring(s), leaf spring(s) or piston retainer(s).
Single, multiple, inflatable bladder(s), compression spring(s), leaf spring(s) or piston(s).
An extendible power cable for the running lights.
A storage compartment for the extendible power cable.
Horizontal/vertical guide rails pointing upward and bolted or welded to each corner of the transporter's base. Said guide rails preferably made from, but not limited to angle iron.
Vertical travel stop plates for the movable platform. Said plates constructed of, but not limited to wood, composite material, metal, plastic or fiberglass. They are secured to the horizontal/vertical guide rails by screws and are equipped with a night time side reflector or marker light.
Single or multiple folding legs on bottom side of the transporter base.
Park, brake and directional lights.

3) A multi-use moving platform framework constructed of, but not limited to wood, composite material, metal, plastic or fiberglass. Said moving platform comprising:
Single, multiple, inflatable bladder(s), compression spring(s), leaf spring(s) or piston retainer(s).
Flat vertical/horizontal slide guides. Said guides being made of, but not limited to nylon or the use of roller bearings.
Holes with threaded inserts or other means for securing a bracket or platform to the top surface.

4) A multi-use tow bar that may fold down and lock in place, be removed or permanently secured to the transporter base mounting plate. Said tow bar being bolted or welded to the mounting plate and said multi-use tow bar comprising:
1) A framework preferably made from, but not limited to square steel tubing.
2) A framework that allows the tow bar to be secured to the side rails and rungs of a ladder. Said tow bar being secured by, but not limited to rung keepers, hold-down plates and bolts.
3) A framework that allows kayak or canoe transporting saddles or pads to be secured thereon.
4) A folding, spring or piston action support arm. Said arm with locking pin, mates to and supports the front end of a special use platform or utility box.
5) A conventional tow hitch, along with either safety chains or cables.
